(19) United States
(12) Patent Application Publication
(10) Pub. No.: US 2016/0258895 A1
(43) Pub. Date: Sep. 8, 2016

(54) SENSOR DEVICE

(71) Applicant: AISAN KOGYO KABUSHIKI KAISHA, Obu-shi, Aichi (JP)

(72) Inventor: Nobuhiro Kato, Tokai-shi (JP)

(21) Appl. No.: 15/032,799

(22) PCT Filed: Sep. 11, 2014
(86) PCT No.: PCT/JP2014/074116

§ 371 Date: Apr. 28, 2016

(30) Foreign Application Priority Data
Oct. 29, 2013 (JP) 2013-224548

(51) Int. Cl. G01N 27/22; F02M 37/00

(52) U.S. Cl. CPC G01N 27/226; F02M 37/00; B60K 2015/0321

(57) ABSTRACT

A sensor device includes a wall 66 defining a storage space 120 configured to store liquid, a pair of electrodes configured to detect a property of the liquid stored inside of the storage space 120, and a set plate 14 closing an opening of a fuel tank 10. The set plate 14 includes a supporter 16 protruding toward an inside of the fuel tank 10 and supporting an electrode 104. The wall 66 has a communication opening 67 communicating between the inside and an outside of the storage space 120. The supporter 16 has a penetrating opening 16a penetrating the supporter 16. One end of the penetrating opening 16a contacts an end of the communication opening 67 located at the outside of the storage space 120.

### TECHNICAL FIELD

The present disclosure relates to a sensor device configured to detect a property of a liquid stored in a container.

### BACKGROUND ART

Japanese Patent Application Publication No. 2012-202513 discloses a fuel sensor that detects an ethanol concentration in a fuel. The fuel sensor is attached to a flange closing an opening of a fuel tank. A fuel path is formed in the flange. The fuel path is connected to a bellows tube along which a fuel discharged from a fuel pump passes. The fuel sensor is interposed in the fuel path of the flange. The fuel sensor detects a permittivity of the fuel between an outer electrode and an inner electrode, thereby detecting an ethanol concentration.

### CITATION LIST

### Patent Literature

Japanese Patent Application Publication No. 2012-202513

### SUMMARY

### Problem to be Solved

A supply passage along which a liquid is supplied into a storage space storing the liquid may get clogged or foreign objects may be deposited in the supply passage. This may change the quality of the liquid. It is desirable that the supply passage be simplified in order to suppress this quality change. The present disclosure provides a technique capable of simplifying the structure of a supply passage along which a liquid is supplied into a storage space.

### Solution to Problem

The present description discloses a sensor device configured to detect a property of a liquid stored in a container. The sensor device may comprise a wall defining a storage space configured to store the liquid, a sensor configured to detect the property of the liquid stored in the storage space, and a lid closing an opening of the container. The lid may include a supporter protruding toward an inside of the container and supporting the wall. The wall may have a first communication opening communicating between the inside and an outside of the storage space. The supporter may have a penetrating opening penetrating the supporter. One end of the penetrating opening may contact an end of the first communication opening located at the outside of the storage space.

In the aforementioned structure, a supply passage along which the liquid is supplied into the storage space is not required to be disposed between the penetrating opening disposed in the lid and the first communication opening disposed in the storage space. This may simplify the structure of a supply passage along which the liquid is supplied into the storage space.

### BRIEF DESCRIPTION OF DRAWINGS

FIG. 1 shows a structure of a fuel tank and its peripheral structure according to a first embodiment;

FIG. 2 shows a structure of a liquid quality sensor and that of a controller according to the first embodiment;

FIG. 3 shows a structure of a liquid quality sensor and that of a controller according to a second embodiment;

FIG. 4 shows a structure of a liquid quality sensor and that of a controller according to a third embodiment;

FIG. 5 shows a structure of a liquid quality sensor and that of a controller according to a modification of the third embodiment;

FIG. 6 shows a structure of a liquid quality sensor and that of a controller according to a forth embodiment; and

FIG. 7 shows a structure of a liquid quality sensor and that of a controller according to a fifth embodiment.

### EMBODIMENT

Principal features of below embodiments will be listed. Notably, technical features described below are independent technical features that may technically be useful alone or in various combinations, and are not limited to the combinations as originally claimed.

### First Feature

The supporter may include an attaching portion attaching a discharge pipe configured to discharge the liquid. The attaching portion may have a second communication opening communicating between the discharge pipe and the penetrating opening. One end of the second communication opening may contact another end of the penetrating opening. In this structure, the discharge pipe and the storage space can communicate with each other easily. Further, since the first communication opening, the penetrating opening, and the second communication opening are disposed continuously, a supply passage along which the liquid is supplied into the storage space may not be required to be disposed between any two or more of the first communication opening, the penetrating opening, and the second communication opening. This may simplify the structure of the supply passage.

### Second Feature

The supporter may have a tubular shape including a bottom. The tubular shape may define an accommodation space accommodating the wall. This structure may prevent exposure of the wall in the container.

### Third Feature

The wall may have a third communication opening communicating between the accommodation space and the storage space. The supporter may have a fourth communication opening communicating between the accommodation space and an inside of the container. An opening area of the fourth communication opening may be smaller than an opening area of the third communication opening. In this structure where the opening area of the fourth communication opening is smaller than that of the third communication opening, when the liquid within the storage space is released into the accommodation space through the third communication opening and then the liquid within the accommodation space is released into the container through the fourth communication opening, reduction in pressure of the liquid within the storage space may be suppressed. Notably, if the third communication opening includes a plurality of communication openings, the “opening area of the third communication opening” may be an opening area of a sum total of respective opening areas of all of the plurality of communication openings. This applies to the “opening area of the fourth communication opening.”

### Fourth Feature

A passage area of at least one part of a passage located downstream of the storage space may be smaller than a passage area of a passage located upstream of the storage space. This structure may suppress reduction in pressure of the liquid within the storage space.

### Fifth Feature

The wall may have a protrusion portion protruding toward the supporter. The supporter may have a concave portion receiving the protrusion portion. In this structure, by inserting the protrusion portion in the concave portion, the wall may be disposed properly at the supporter.

### Sixth Feature

The first communication opening may penetrate the protrusion portion. The penetrating opening may penetrate the concave portion. In this structure, the position of the first communication opening and that of the penetrating opening relative to each other may be maintained properly using the protrusion portion and the concave portion.

### Seventh Feature

The sensor device may further comprise a seal disposed between the protrusion portion and the concave portion. This structure may suppress leakage of the liquid within the storage space from between the protrusion portion and the concave portion.

### Eighth Feature

The container may be a fuel tank storing a fuel. A reserve cup storing the fuel sucked by a fuel pump may be disposed in the fuel tank. The sensor device may further comprise a communication pipe configured to communicate between the storage space and the reserve cup. The communication pipe may be attached to the supporter. In this structure, the liquid having passed through the storage space may be released properly into the reserve cup.

### Ninth Feature

The sensor may comprise an outer electrode having a tubular shape and an inner electrode accommodated in an inside of the outer electrode. A part of the storage space may be defined by the outer electrode. The supporter may have a tubular shape including a bottom that defines an accommodation space accommodating the wall. One end of the outer electrode may contact a bottom of the accommodation space. The sensor device may further comprise a seal sealing a contacting portion between the outer electrode and the supporter. This structure may suppress leakage of the liquid within the storage space from a gap between the outer electrode and the bottom of the accommodation space.

### Tenth Feature

A cross-section area of an end part of the outer electrode vertical to an axis direction of the outer electrode, the end part located close to the bottom of the accommodation space, may be smaller than a cross-section of other part of the outer electrode vertical to the axis direction. The seal may be disposed in an outside of the outer electrode close to the bottom of the accommodation space. This structure may suppress movement of the seal in the axis direction of the outer electrode using the part of the outer electrode having a large cross-section area and the bottom of the accommodation space.

### Eleventh Feature

The inner electrode may have a circumference surface elongating along the axis direction and having a tubular shape. A cross-section area of an end part of the inner electrode vertical to the axis direction, the end part located close to the bottom of the accommodation space, may be smaller than a cross-section of other part of the inner electrode vertical to the axis direction. This structure may allow the liquid to flow smoothly between the outer electrode and the inner electrode. As a result, stagnation of the liquid within the storage space may be suppressed.

### First Embodiment

A fuel supply unit 1 of the present embodiment is mounted on a vehicle such as an automobile, and supplies a fuel to an unillustrated engine. The fuel supply unit 1 includes a fuel tank 10, a fuel pump unit 30 and a sensor device 2. Gasoline or a mixture fuel of gasoline and ethanol is stored in the fuel tank 10.

The fuel pump unit 30 includes a low-pressure filter 32, a pump main body 34, a high-pressure filter 36, a reserve cup 8, a pressure regulator 42, and a discharge port 12. The low-pressure filter 32, the pump main body 34, the high-pressure filter 36, the reserve cup 8 and the pressure regulator 42 are disposed within the fuel tank 10. The pump main body 34 sucks the fuel within the reserve cup 8 from the suction port 34a of the pump main body 34 and increases the pressure. The pump main body 34 discharges the fuel whose pressure is increased from a discharge port 34b into a case 36a of the high-pressure filter 36.

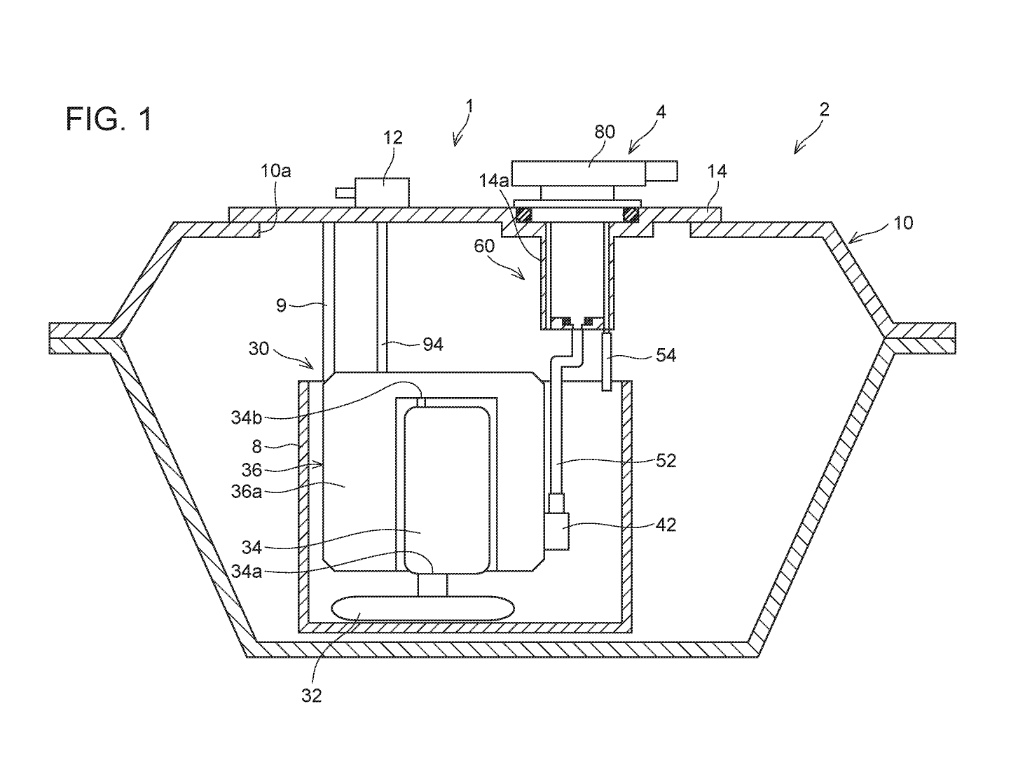

The low-pressure filter 32 is formed of nonwoven fabric into a shape of a bag. An interior of the low-pressure filter 32 communicates with the suction port 34a of the pump main body 34. The high-pressure filter 36 includes the case 36a and a filter member (not shown). Although schematically shown in FIG. 1, the case 36a is disposed in a circumferential direction of the pump main body 34. The fuel flowing into the case 36a is filtered by the filter member of the high-pressure filter 36, and is fed out to a pipe 94. The pressure regulator 42 is connected to the case 36a. When the pressure of the fuel within the case 36a becomes equal to or more than a predetermined pressure, the pressure regulator 42 discharges excess fuel within the case 36a to a pipe 52. In this way, the pressure of the fuel within the case 36a is adjusted to be a constant pressure. The fuel within the fuel tank 10 is adjusted to have a constant pressure by the pump main body 34 and the pressure regulator 42 and passes from the case 36a through the discharge port 12 and is fed by pressure to the engine (not shown).

The pump main body 34, the high-pressure filter 36 and the low-pressure filter 32 are disposed within the reserve cup 8. The reserve cup 8 is fixed by a support column 9 to a set plate 14 of the fuel tank 10. Fuel outside the reserve cup 8 is fed into the reserve cup 8 by a jet pump not shown.

The sensor device 2 includes a sensor unit 4 and the set plate 14. The set plate 14 closes the opening 10a of the fuel tank 10. The set plate 14 has a disk shape. The discharge port 12 and the sensor unit 4 are attached to the set plate 14.

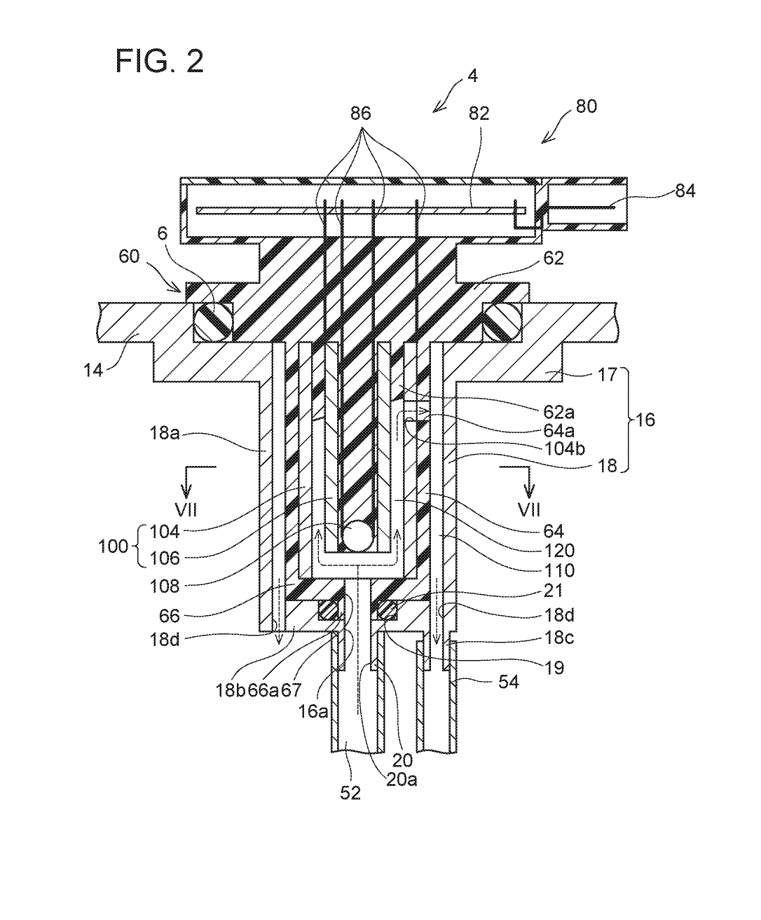

As shown in FIG. 2, a supporter 16 protruding toward an inside of the fuel tank 10 is formed in a part of the set plate 14. The supporter 16 includes a contacting portion 17 and an accommodation portion 18. The contacting portion 17 has a circular concave portion. The accommodation portion 18 is formed in a central part of the contacting portion 17. The accommodation portion 18 is recessed from a bottom of the contacting portion 17 toward the fuel tank 10 and has a cylindrical tubular shape including a bottom. The accommodation portion 18 defines an accommodation space 110. A concave portion 19 recessed in a circular tubular shape is disposed at a central part of a bottom wall 18b of the accommodation portion 18. The concave portion 19 is disposed coaxially with the accommodation portion 18. A penetrating opening 16a is formed in a central part of the concave portion 19. The penetrating opening 16a penetrates the bottom wall 18b in an axis direction of the accommodation portion 18 (i.e., in a vertical direction).

An attaching portion 20 is disposed at a lower surface of the bottom wall 18b. The attaching portion 20 protrudes vertically downwardly from the lower surface of the bottom wall 18b. The attaching portion 20 has a circular tubular shape. A communication opening 20a is formed in a central part of the attaching portion 20. The communication opening 20a penetrates the attaching portion 20 in the vertical direction. An upper end of the communication opening 20a contacts a lower end of the penetrating opening 16a. In other words, the communication opening 20a and the penetrating opening 16a are disposed continuously. The communication opening 20a has the same diameter as the penetrating opening 16a.

A plurality of discharge openings 18d is formed at an edge part of the bottom wall 18b. Each of the discharge openings 18d penetrates the bottom wall 18b in the vertical direction. An attaching portion 18c of a circular tubular shape protrudes from a lower end of one of the plurality of discharge openings 18d. A communication tube 54 communicating between the accommodation space 110 and an inside of the reserve cup 8 is attached to the attaching portion 18c.

The sensor unit 4 is supported by the supporter 16. Specifically, the sensor unit 4 is disposed at an upper end part of the fuel tank 10. The sensor unit 4 includes a liquid quality sensor 60 and a controller 80.

The liquid quality sensor 60 is disposed in the supporter 16. The liquid quality sensor 60 includes an upper wall 62, a peripheral wall 64, a bottom wall 66, an electrode pair 100, and a thermistor 108. The electrode pair 100 includes an electrode 104 and an electrode 106. Each of the electrodes 104 and 106 is made of a material having conductivity. The electrode 104 is disposed coaxially with the penetrating opening 16a. The electrode 104 has a circular tubular shape. A central axis of the electrode 104 extends in the vertical direction. The electrode 104 has a communication opening 104b provided near an upper end of the electrode 104 for communication between an inside and an outside of the electrode 104. The communication opening 104b has a diameter larger than that of the discharge opening 18d.

An opening area of the communication opening 104b is smaller than an opening area of the plurality of discharge openings 18d. The opening area of the plurality of discharge openings 18d means a sum total of respective opening areas of all the discharge openings 18d. Each of the opening area of the communication opening 104b and that of the plurality of discharge openings 18d is smaller than all of an opening area of the penetrating opening 16a, that of a communication opening 67, and that of the communication opening 20a.

The electrode 106 is disposed inside the electrode 104. The electrode 106 has a cylindrical shape having a central axis same as that of the electrode 104. The length of the electrode 106 in a direction of its central axis is shorter than that of the electrode 104 in the direction of its central axis. An upper end of the electrode 106 is positioned at the same height as that of the electrode 104. The electrode 106 has an outer circumference surface that entirely faces an inner circumference surface of the electrode 104. A fuel is stored between the electrodes 104 and 106. An inside of the electrode 106 is filled with resin so as to prevent entry of the fuel into the inside of the electrode 106.

The thermistor 108 is disposed inside the electrode 106. The thermistor 108 is covered with resin. The thermistor 108 is disposed at the lower end of the electrode 106.

The electrode 104 has an outer circumference surface entirely covered with the peripheral wall 64. The peripheral wall 64 is made of a non-conductive material such as resin. The peripheral wall 64 has a cylindrical shape having a central axis same as that of the electrode 104. A length of the peripheral wall 64 in a direction of its central axis is the same as that of the electrode 104 in the direction of its central axis. A lower end of the peripheral wall 64 is positioned at the same height as that of the electrode 104. The peripheral wall 64 has a communication opening 64a in a position overlapping a position of the communication opening 104b. The communication opening 64a has a diameter same as that of the communication opening 104b and larger than that of the discharge opening 18d. The peripheral wall 64 has an outer diameter smaller than an inner diameter of a peripheral wall 18a of the accommodation portion 18.

The upper wall 62 is formed integrally with the peripheral wall 64 at the upper end of the peripheral wall 64. The upper wall 62 is formed integrally with the peripheral wall 64. The upper wall 62 is fitted to the contacting portion 17 through an O-ring 6. On an inner circumference surface side of the O-ring 6, a part of a lower surface of the upper wall 62 facing the bottom of the contacting portion 17 contacts this bottom of the contacting portion 17. The lower surface of the upper wall 62 further contacts respective upper ends of the peripheral wall 64 and the electrodes 104 and 106. The lower surface of the upper wall 62 includes a support wall 62a of a cylindrical shape protruding downward from the lower surface of the upper wall 62.

The support wall 62a is disposed in a gap between the electrodes 104 and 106. The support wall 62a and the peripheral wall 64 together hold an upper end part of the electrode 104 therebetween, thereby supporting the upper end of the electrode 104. Further, the support wall 62a receives the electrode 106 fitted to a place inside the support wall 62a, thereby supporting the upper end of the electrode 106. A lower end surface of the support wall 62a is tilted in such a manner as to be placed in a higher position with a shorter distance to the communication opening 104b. In a position overlapping the communication opening 104b in a circumferential direction, a lower end surface of the support wall 62a is positioned at substantially the same height as an upper end of the communication opening 104b.

The bottom wall 66 is formed integrally with the peripheral wall 64 at the lower end of the peripheral wall 64. The lower end of the electrode 104 contacts the upper surface of the bottom wall 66. The bottom wall 66 has a gap defined between the bottom wall 66 and the lower end of the electrode 106. The bottom wall 66 has the communication opening 67 formed in a central part of the bottom wall 66. The communication opening 67 penetrates the lower surface and the upper surface of the bottom wall 66. The communication opening 67 is disposed coaxially with the penetrating opening 16a and faces the lower end of the electrode 106. Further, the communication opening 67 has the same diameter as the penetrating opening 16a.

The lower surface of the bottom wall 66 contacts the bottom wall of the accommodation portion 18. A protrusion portion 66a of a cylindrical shape is disposed at the lower surface of the bottom wall 66. The protrusion portion 66a protrudes downwardly. The communication opening 67 passes through a central part of the protrusion portion 66a. The protrusion portion 66a has an outer diameter smaller than an inner diameter of the concave portion 19. The protrusion portion 66a is inserted in the concave portion 19 through an O-ring 21. This structure may position the liquid quality sensor 60 relative to the accommodation portion 18 using the protrusion portion 66a and the concave portion 19. Further, leakage of the fuel from between the protrusion portion 66a and the accommodation portion 18 may be suppressed using the O-ring 21. The electrode 104, the upper wall 62, and the bottom wall 66 define a storage space 120 storing the fuel. Specifically, in the storage space 120, the communication opening 67 facilitates communication between the storage space 120 and the fuel tank 10. Further, the communication openings 104b and 64a facilitates communication between the storage space 120 and the accommodation space 110.

The controller 80 is fixed above the upper wall 62. The controller 80 includes a control circuit 82 and an external terminal 84. The external terminal 84 supplies power to the control circuit 82. A CPU, a memory, etc. are installed on the control circuit 82. The control circuit 82 is a circuit configured to detect a temperature of the fuel and an ethanol concentration in the fuel using the liquid quality sensor 60.

### Operation of Fuel Supply Unit 1

The fuel supply unit 1 is driven when a driver starts a vehicle. As shown in FIG. 1, as the fuel supply unit 1 is driven, the fuel within the reserve cup 8 passes through the low-pressure filter 32 to be sucked into the pump main body 34. This structure may prevent entry of a foreign object into the pump main body 34 using the low-pressure filter 32. The fuel within the pump main body 34 is increased in pressure by an impeller in the pump main body 34 and discharged from the discharge port 34b into the high-pressure filter 36. The fuel is filtered by the filter member of the high-pressure filter 36 and fed out to the pipe 94. Then, the fuel is supplied to the engine from the discharge port 12.

When the pressure of the fuel within the high-pressure filter 36 becomes equal to or more than a predetermined pressure, the pressure regulator 42 discharges an excess of the fuel within the high-pressure filter 36 to the pipe 52. As shown by dashed arrows of FIG. 2, the fuel within the pipe 52 passes through the communication opening 20a, the penetrating opening 16a, and the communication opening 67 to flow into the storage space 120. The fuel having flown into the storage space 120 passes through between the electrodes 104 and 106 along the outer circumference surface of the electrode 106. The fuel flows from bottom to top in the storage space 120, passes through the communication openings 104b and 64a, and then flows from the storage space 120 into the accommodation space 110. The contact between the upper wall 62 and the contacting portion 17 makes it unlikely that the fuel flowing in the storage space 120 will reach the O-ring 6. This structure can properly prevent leakage of the fuel within the storage space 120. This structure can further prevent collision of a high-pressure fuel with the O-ring 6.

The fuel having flown into the accommodation space 110 flows from top to bottom in the accommodation space 110 and is then discharged to the outside of the accommodation space 110 from the plurality of discharge openings 18d. The fuel discharged from the discharge opening 18d, among the plurality of discharge openings 18d, where the communication tube 54 is disposed is released into the reserve cup 8. This structure may suppress reduction in the fuel within the reserve cup 8.

While the fuel supply unit 1 is driven, the control circuit 82 detects an ethanol concentration in the fuel using the liquid quality sensor 60. The control circuit 82 detects the ethanol concentration repeatedly until the engine of the vehicle stops.

Specifically, the control circuit 82 converts power supplied from a battery (not shown in the drawings) to a signal of a predetermined frequency (from 10 Hz to 3 MHz, for example) (specifically, AC current), and supplies the signal to the electrode 106 through conductors 86. The control circuit 82 is further connected to the electrode 104. The signal supplied to the electrode 106 returns from the electrode 104 to the control circuit 82. As a result, charges are accumulated in the electrode pair 100 to generate a capacitance. The control circuit 82 calculates the capacitance of the electrode pair 100 based on the signal having returned from the electrode 104 to the control circuit 82. Next, the control circuit 82 supplies DC power to the thermistor 108 through the conductors 86 to detect a temperature of the thermistor 108 based on a resistance value of the thermistor 108. The temperature of the thermistor 108 is substantially the same as the temperature of the fuel within the storage space 120. This allows the control circuit 82 to detect the temperature of the fuel within the storage space 120 through detection of the temperature of the thermistor 108.

A gap between the electrode 104 and the electrode 106 is full of the fuel. Thus, the capacitance of the electrode pair 100 changes in correlation with the permittivity of the fuel. Gasoline and ethanol largely differs in permittivity, so that the permittivity of the fuel changes in a manner that depends on an ethanol concentration. The permittivity of the fuel changes in correlation with the temperature of the fuel. The control circuit 82 includes a circuit configured to specify the capacitance of the electrode pair 100 using a signal supplied to the electrode 106 and a circuit configured to convert the specified capacitance to the permittivity of the fuel that are mounted on the control circuit 82. Further, the control circuit 82 stores a database used for calculating an ethanol concentration in the fuel based on the permittivity and the temperature of the fuel. The database is specified in advance by experiment or by analysis. When receiving a signal having returned from the electrode 104 to the control circuit 82, the control circuit 82 refers to the database to detect an ethanol concentration in the fuel based on the permittivity of the fuel. The control circuit 82 outputs the detected ethanol concentration to an ECU (abbreviation for engine control unit). The ECU adjusts the amount of the fuel to be supplied to the engine in a manner that depends on the ethanol concentration in the fuel.

### Effect of First Embodiment

In the aforementioned sensor device 2, a supply passage along which the fuel is supplied into the storage space 120 is not required to be disposed between the penetrating opening 16a of the accommodation portion 18 and the communication opening 67 disposed in the storage space 120. This may simplify the structure of a supply passage along which the fuel is supplied from the pump main body 34 into the storage space 120.

Each of the opening area of the communication opening 104d and that of the plurality of discharge openings 18d is smaller than all of the opening area of the penetrating opening 16a, that of the communication opening 67, and that of the communication opening 20a. This structure may suppress reduction in pressure of the fuel within the storage space 120. This may make it unlikely that the fuel will vaporize due to reduction in pressure of the fuel within the storage space 120. The opening area of the communication opening 104d is smaller than that of the plurality of discharge openings 18d. This structure can also suppress reduction in pressure of the fuel within the storage space 120.

The pipe 52 connected to the pump main body 34 is attached to the set plate 14. Thus, removing the liquid quality sensor 60 from the set plate 14 does not involve removal of the pipe 52. As a result, the liquid quality sensor 60 may be removed easily from the set plate 14.

### Correspondence

A fuel of the present embodiment is an example of a “liquid,” the fuel tank 10 is an example of a “container,” and an ethanol concentration is an example of a “property.” The electrode 104 is an example of a “wall,” the electrodes 104 and 106 are an example of a “sensor,” and the set plate 14 is an example of a “lid.” The communication openings 67 and 20a and the discharge opening 18d are an example of a “first communication opening,” an example of a “second communication opening,” and an example of a “fourth communication opening” respectively. The communication openings 104b and 64a are an example of a “third communication opening.”

### Second Embodiment

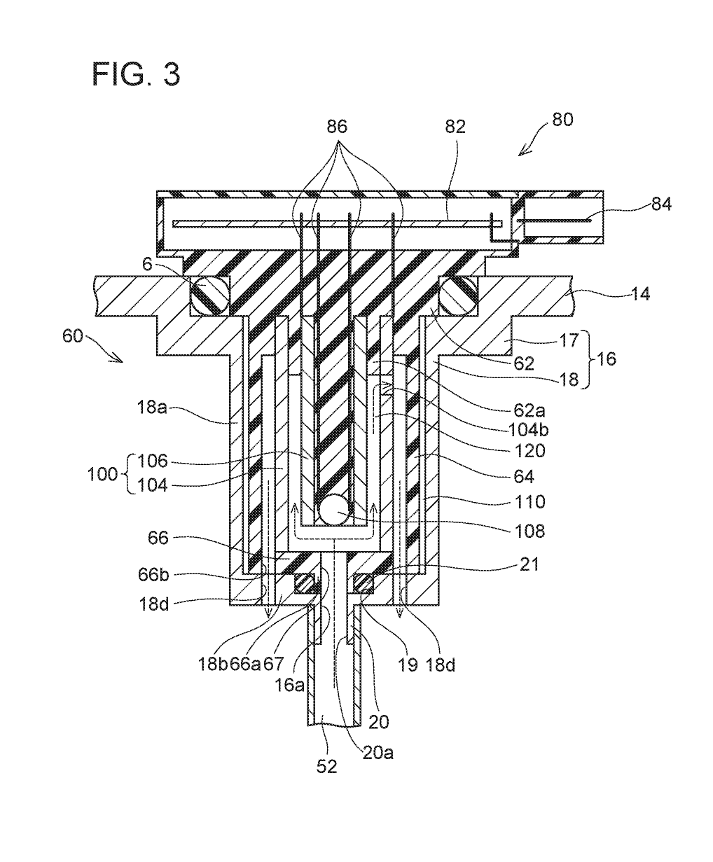

A difference of a liquid quality sensor 60 of a second embodiment from the liquid quality sensor 60 of the first embodiment is described by referring to FIG. 3. In the present embodiment, a gap is formed between the electrode 104 and the peripheral wall 64. The storage space 120 communicates with the gap between the electrode 104 and the peripheral wall 64 through the communication opening 104b. As a result, a fuel flows from the storage space 120 into the gap between the electrode 104 and the peripheral wall 64 within the accommodation space 110. The fuel in the gap between the electrode 104 and the peripheral wall 64 does not flow toward an outer circumference surface of the peripheral wall 64 but passes through the discharge opening 18d from the gap between the electrode 104 and the peripheral wall 64. Then, the fuel flows out into the fuel tank 10.

A gap between the peripheral wall 64 and the peripheral wall 18a of the accommodation portion 18 is narrower than that of the first embodiment. The bottom wall 66 has communication openings 66b located coaxially with each discharge opening 18d of the accommodation portion 18. The communication openings 66b penetrate the bottom wall 66 in the vertical direction. The communication openings 66b have a diameter same as that of the discharge opening 18d and larger than that of the communication opening 104b. The sensor device 2 of the present embodiment may achieve effect comparable to that of the sensor device 2 of the first embodiment.

### Correspondence

The communication openings 67, 20a, and 104b are an example of the “first communication opening,” an example of the “second communication opening,” and an example of the “third communication opening” respectively. The communication opening 66b and the discharge opening 18d are an example of the “fourth communication opening.”

### Third Embodiment

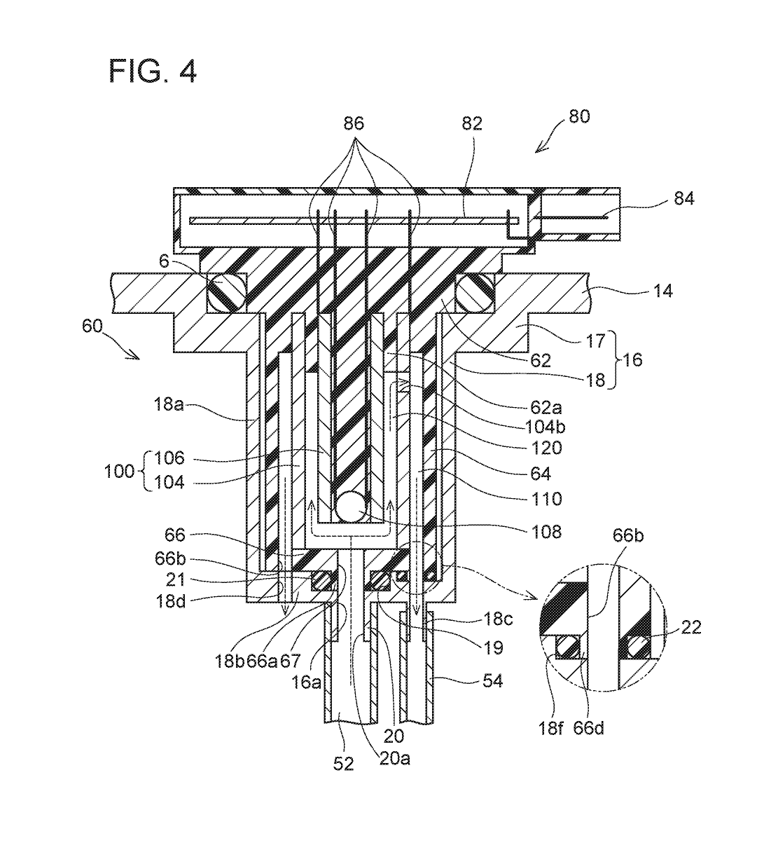

A difference of a liquid quality sensor 60 of a third embodiment from the second embodiment is described by referring to FIG. 4. In the liquid quality sensor 60 of the third embodiment, the bottom wall 66 has a protrusion portion 66d of a cylindrical shape formed in a position where at least one communication opening 66b of a plurality of communication openings 66b is disposed. The protrusion portion 66d lets this communication opening 66b pass through a central part of the protrusion portion 66d.

To correspond to this structure, a concave portion 18f is disposed at the upper surface of the bottom wall of the accommodation portion 18. The concave portion 18f is formed into a columnar shape. An outer diameter of the protrusion portion 66d is smaller than an inner diameter of the concave portion 18f. The protrusion portion 66d is inserted in the concave portion 18f through an O-ring 22. This structure may locate the liquid quality sensor 60 in a position relative to the accommodation portion 18 by the protrusion portion 66d and the concave portion 18f. Further, leakage of a fuel from between the protrusion portion 66d and the accommodation portion 18 may be suppressed using the O-ring 22. The sensor device 2 of the third embodiment may achieve effect comparable to that of the sensor device 2 of the first embodiment.

### Modification of Third Embodiment

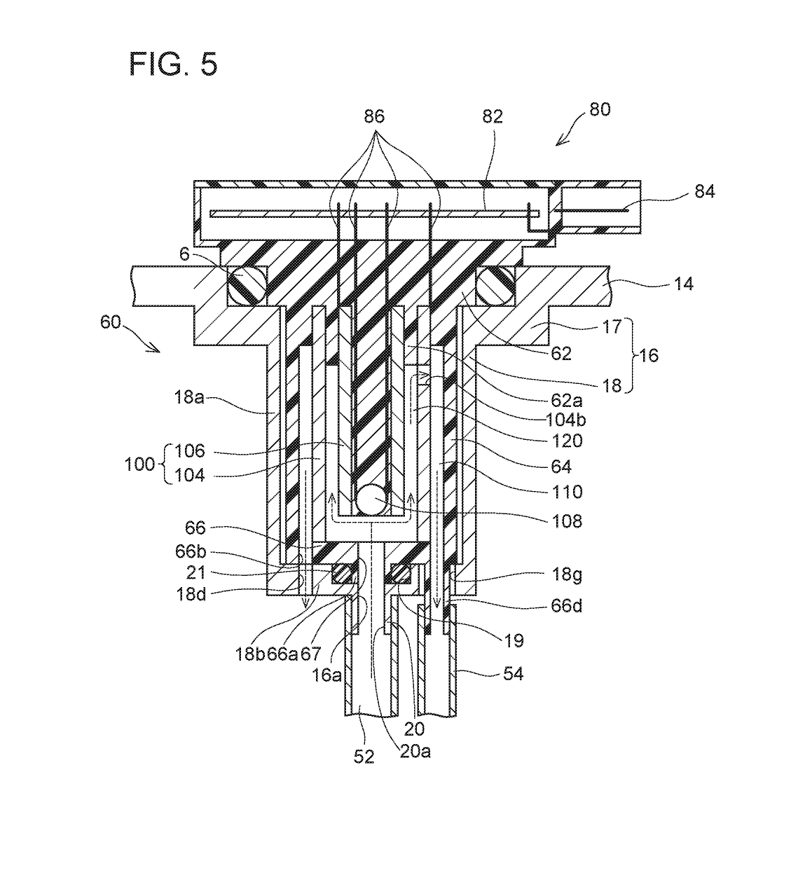

As shown in FIG. 5, the protrusion portion 66d may pass through a penetrating opening 18g of the bottom wall 18b of the accommodation portion 18 to protrude into the fuel tank 10. In this case, the concave portion 18f and the O-ring 22 may be omitted from the liquid quality sensor 60. The communication tube 54 may be attached to the protrusion portion 66d. The outer diameter of the communication tube 54 may be larger than the diameter of the penetrating opening 18g.

### Fourth Embodiment

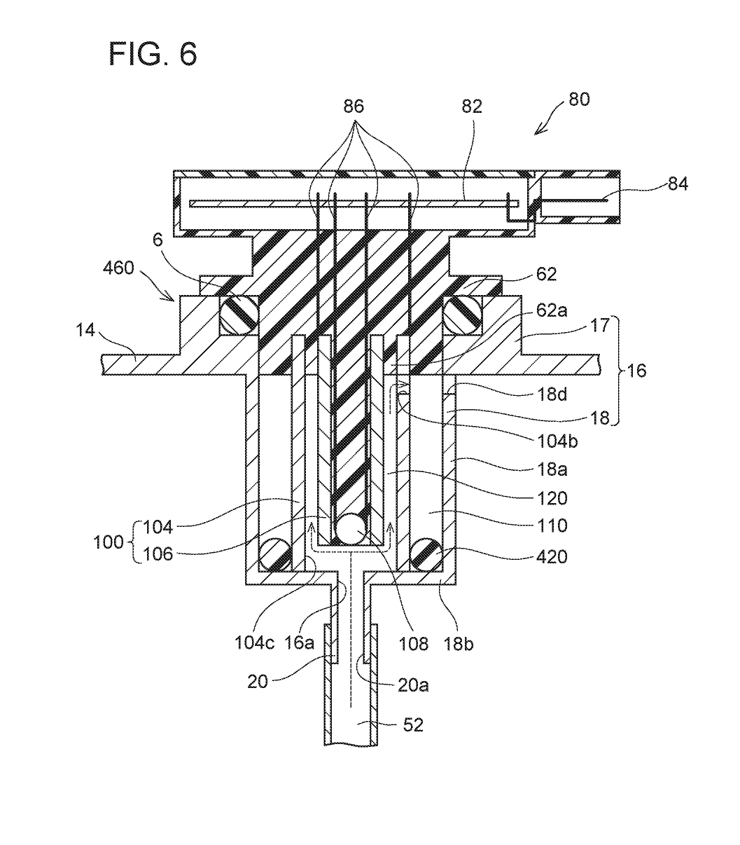

A difference of a liquid quality sensor 460 of a fourth embodiment from that of the first embodiment is described by referring to FIG. 6. Compared to the liquid quality sensor 60 of the first embodiment, the liquid quality sensor 460 does not have the peripheral wall 64 and the bottom wall 66. In the liquid quality sensor 460, the bottom wall 18b of the accommodation portion 18 contacts the lower end of the electrode 104. That is, the storage space 120 is defined by the electrode 104, the upper wall 62, and the bottom wall 18b. In the storage space 120, an opening 104c (an example of the “first communication opening”) at the lower end of the electrode 104 facilitates communication between an inside and an outside of the storage space 120. The lower end of the opening 104c contacts the upper end of the penetrating opening 16a. The opening 104c and the penetrating opening 16a are disposed continuously.

An O-ring 420 is disposed outside a lower end part of the electrode 104. The O-ring 420 is fitted between the electrode 104 and the peripheral wall 18a of the accommodation portion 18. Leakage of a fuel within the storage space 120 to the accommodation space 110, from a gap between the lower end of the electrode 104 and the accommodation portion 18 can be suppressed by the O-ring 420. The discharge opening 18d communicating between the accommodation space 110 and the fuel tank 10 is disposed at the upper end of the peripheral wall 18a.

In the set plate 14 of the present embodiment, the contacting portion 17 of the supporter 16 has a circular tubular shape protruding from the set plate 14 toward a side opposite the fuel tank 10. The upper wall 62 contacts the upper end of the contacting portion 17 and is fitted to the contacting portion 17 through the O-ring 6. The upper wall 62 is fitted in an opening positioned in a central part of the contacting portion 17. This structure may prevent collision of a high-pressure fuel within the accommodation space 110 with the O-ring 6. The sensor device 2 of the present embodiment can achieve effect comparable to that of the sensor device 2 of the first embodiment.

### Fifth Embodiment

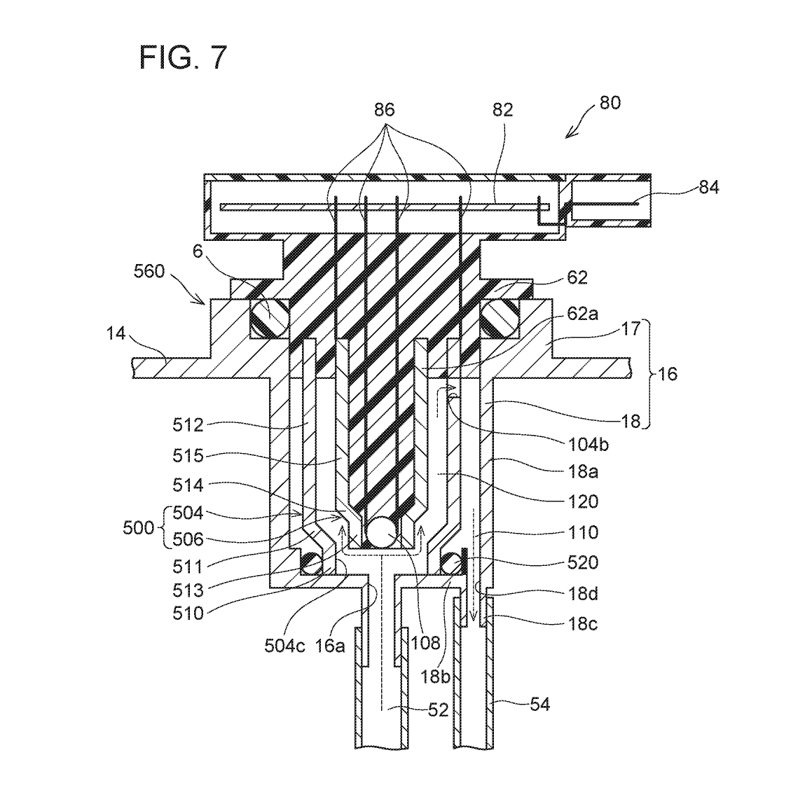

A difference of a liquid quality sensor 560 of a fifth embodiment from that of the fourth embodiment is described by referring to FIG. 7. The liquid quality sensor 560 includes an electrode pair 500 instead of the electrode pair 100. The electrode pair 500 includes an electrode 504 and an electrode 506. The electrode 504 includes a lower end part 510 of a circular tubular shape, an upper end part 512 of a circular tubular shape, and a connecting part 511 connecting the lower end part 510 and the upper end part 512. The outer diameter of the lower end part 510 is smaller than that of the upper end part 512. In other words, the upper end of the connecting part 511 has the same outer diameter as the upper end part 512. The lower end of the connecting part 511 has the same outer diameter as the lower end part 510. The connecting part 511 is gradually reduced in outer diameter from top to bottom at an intermediate area of the connecting part 511. In other words, a cross-section area of the lower end part 510 vertical to an axis direction of the electrode 504 is smaller than a cross-sectional area of the upper end part 512 and that of the connecting part 511 vertical to the axis direction of the electrode 504. The structure of the electrode 504 is the same in the other respects as that of the electrode 104.

The storage space 120 is defined by the electrode 504, the upper wall 62, and the bottom wall 18b. In the storage space 120, an opening 504c (an example of the “first communication opening”) at the lower end of the electrode 504 facilitates communication between the inside and the outside of the storage space 120. The lower end of the opening 504c contacts the upper end of the penetrating opening 16a. The opening 504c and the penetrating opening 16a are disposed continuously.

An O-ring 520 is disposed outside the lower end part 510 of the electrode 504. The O-ring 520 has an outer diameter slightly smaller than that of the lower end part 510. This structure may prevent the O-ring 520 from moving in the axis direction of the electrode 504. Further, the thickness of the O-ring 520 is greater than a gap between the upper end part 512 and the peripheral wall 18a of the accommodation portion 18. This structure may also prevent the O-ring 520 from moving in the axis direction of the electrode 504.

The electrode 506 is accommodated in the storage space 120. The electrode 506 includes a lower end part 513 of a cylindrical shape, an upper end part 515 of a circular tubular shape, and a connecting part 514 connecting the lower end part 513 and the upper end part 515. The outer diameter of the lower end part 513 is smaller than that of the upper end part 515. The upper end of the connecting part 514 has the same outer diameter as the upper end part 515. The lower end of the connecting part 514 has the same outer diameter as the lower end part 513. The connecting part 514 is gradually reduced in outer diameter from top to bottom at an intermediate area of the connecting part 514. In other words, a cross-section area of the lower end part 513 vertical to an axis direction of the electrode 506 is smaller than a cross-sectional area of the upper end part 515 and that of the connecting part 514 vertical to the axis direction of the electrode 506. An outer circumference surface of the electrode 506 is formed parallel to an inner circumference surface of the electrode 504. This structure allows a fuel within the storage space 120 to flow smoothly without causing stagnation of the fuel. The structure of the electrode 506 is the same in the other respects as that of the electrode 106.

While the embodiments of the present description have been shown and described in detail, the foregoing description is merely illustrative and does not limit the scope of claims. The technique described in the scope of claims may include numerous modifications and variations of the examples described above specifically.

### Modifications

(1) In the aforementioned embodiments, the sensor device 2 detects an ethanol concentration in the fuel using the liquid quality sensor 60. Alternatively, the sensor device 2 may detect a degree of deterioration of the fuel (such as a degree of oxidation of the fuel) or a liquid level of the fuel, for example.

(2) The “sensor device” may be used for detection of a property of a liquid other than a fuel such as cooling water (such as detection of a degree of deterioration, a type, or a liquid level of the cooling water), for example.

(3) In each of the aforementioned embodiments, the pipe 52 is connected to the pressure regulator 42. Alternatively, the pipe 52 may branch off from the pipe 94 or may be connected to a vapor jet of the pump main body 34.

(4) In each of the aforementioned embodiments, the number of electrodes of a liquid quality sensor such as the liquid quality sensor 60 is not limited to two. A liquid quality sensor such as the liquid quality sensor 60 may include three or more electrodes. The liquid quality sensor 60 may be a sensor other than an electrode.

(5) In each of the aforementioned embodiments, the control circuit 82 detects an ethanol concentration, etc. based on the capacitance of each electrode pair, specifically, based on the permittivity of the fuel. Alternatively, the control circuit 82 may detect an ethanol concentration based on a value obtained by using an electrode pair different from the capacitance of the electrode pair such as a conductivity of the fuel obtained by using the electrode pair, for example.

(6) In each of the aforementioned embodiments, the supporter 16 has the accommodation portion 18 of a cylindrical tubular shape including a bottom. However, this is not the only shape of the supporter 16. The shape of the supporter 16 may also be determined in such a manner that a part of the liquid quality sensor 60 is not accommodated by the supporter 16 but is exposed to the fuel tank 10. For example, the supporter 16 may have one or more columns extending from the set plate 14 into the fuel tank 10.

(7) In the aforementioned third embodiment, the protrusion portion 66d is inserted in the concave portion 18f through the O-ring 22. Alternatively, the O-ring 22 may be omitted.

(8) In the aforementioned embodiments, each of the opening area of the communication opening 104d, that of the communication opening 64a, and that of the plurality of discharge openings 18d is smaller than all of the opening area of the penetrating opening 16a, that of the communication opening 67, and that of the communication opening 20a. Alternatively, at least one of the opening area of the communication opening 104d, that of the communication opening 64a, and that of the plurality of discharge openings 18d may be larger than any one of the opening area of the penetrating opening 16a, that of the communication opening 67, and that of the communication opening 20a.

(9) In the aforementioned embodiments, the opening area of the communication opening 104d is smaller than that of the plurality of discharge openings 18d. Alternatively, the opening area of the communication opening 104d may be larger than that of the plurality of discharge openings 18d. Likewise, the opening area of the communication opening 64a is smaller than that of the plurality of discharge openings 18d. Alternatively, the opening area of the communication opening 64a may be larger than that of the plurality of discharge openings 18d.

(10) In each of the aforementioned embodiments, the plurality of discharge openings 18d is formed at the edge part of the bottom wail 18. However, the number of the discharge openings 18d is not limited. One discharge opening 18d may be formed at the edge part of the bottom wall 18. The communication openings 64a, 104d, 67, and 20a may include a plurality of communication openings 64a, a plurality of communication openings 104d, a plurality of communication openings 67, and a plurality of communication openings 20a respectively. The penetrating opening 16a may include a plurality of penetrating openings 16a. In this modification, at least one of the opening area of the plurality of communication openings 104d (i.e., the sum total of respective opening areas of all the communication openings 104d), an opening area of the plurality of communication openings 64a (i.e., the sum total of respective opening areas of all the communication openings 64a), and the opening area of the plurality of discharge openings 18d may be larger than any one of an opening area of the plurality of penetrating openings 16a (specifically, the sum total of respective opening areas of all the penetrating openings 16a), an opening area of the plurality of communication openings 67 (specifically, the sum total of respective opening areas of all the communication openings 67), and an opening area of the plurality of communication openings 20a (specifically, the sum total of respective opening areas of all the communication openings 20a). In other words, a passage area of at least one part of a fuel passage located downstream of the storage space 120 can be said to be smaller than a passage area in any position of a fuel passage located upstream of the storage space 120. At least one of the opening area of the plurality of communication openings 104d and that of the plurality of communication openings 64a may be smaller than the opening area of the plurality of discharge openings 18d.

The technical features described in the description or the drawings may technically be useful alone or in various combinations, and are not limited to the combinations as originally claimed. Further, the art described in the description or the drawings may concurrently achieve a plurality of aims, and technical significance thereof resides in achieving any one of such aims.

### REFERENCE SIGNS LIST

1 Fuel supply unit

2 Sensor device

4 Sensor unit

6 O-ring

10 Fuel tank

14 Set plate

16 Supporter

16a Penetrating opening

17 Contacting portion

18 Accommodation portion

18a Peripheral wall

18b Bottom wall

18c Attaching portion

18d Discharge opening

19 Concave portion

20 Attaching portion

21,22 O-ring

30 Fuel pump unit

60 Liquid quality sensor

66d Protrusion potion

67 Communication opening

80 Controller

104, 106 Electrode

1. A sensor device configured to detect a property of a liquid stored in a container comprising:
a wall defining a storage space configured to store the liquid;
a sensor configured to detect the property of the liquid stored in the storage space;
a lid closing an opening of the container, the lid comprising a supporter protruding toward an inside of the container and supporting the wall at an outside of the wall; and
a seal fit between the wall and the supporter,
wherein
the wall has a first communication opening communicating between the inside and an outside of the storage space,
the supporter has a penetrating opening penetrating the supporter,
one end of the penetrating opening contact an end of the first communication opening located at the outside of the storage space, and
the seal is fit between the outside of the wall and the supporter at an outside of the first communication opening.

2. The sensor device as in claim 1, wherein
the supporter comprises an attaching portion attaching a discharge pipe configured to discharge the liquid,
the attaching portion has a second communication opening communicating between the discharge pipe and the penetrating opening, and
one end of the second communication opening contact another end of the penetrating opening.

3. The sensor device as in claim 1, wherein
the supporter has a tubular shape including a bottom, and
the tubular shape defines an accommodation space accommodating the wall.

4. The sensor device as in claim 3, wherein
the wall has a third communication opening communicating between the accommodation space and the storage space,
the supporter has a fourth communication opening communicating between the accommodation space and an inside of the container, and
an opening area of the fourth communication opening is smaller than an opening area of the third communication opening.

5. The sensor device as in claim 1, wherein
a passage area of at least one part of a passage located downstream of the storage space is smaller than a passage area of a passage located upstream of the storage space.

6. The sensor device as in claim 1, wherein
the wall has a protrusion portion protruding toward the supporter, and
the supporter has a concave portion receiving the protrusion portion.

7. The sensor device as in claim 6, wherein
the first communication opening penetrates the protrusion portion, and
the penetrating opening penetrates the concave portion.

8. The sensor device as in claim 6, further comprising:
a seal disposed between the protrusion portion and the concave portion.

9. The sensor device as in claim 1, wherein
the container is a fuel tank storing a fuel,
a reserve cup is disposed in the fuel tank, and
the reserve cup stores the fuel sucked by a fuel pump, and
the sensor device further comprises:
a communication pipe configured to communicate between the storage space and the reserve cup, and
the communication pipe is attached to the supporter.

10. The sensor device as in claim 1, wherein
the sensor comprises an outer electrode having a tubular shape and an inner electrode accommodated in an inside of the outer electrode,
a part of the storage space is defined by the outer electrode,
the supporter has a tubular shape including a bottom,
the tubular shape defines an accommodation space accommodating the wall,
one end of the outer electrode contact a bottom of the accommodation space, and
the seal seals a contacting portion between the outer electrode and the supporter.

11. The sensor device as in claim 10, wherein
a cross-section area of an end part of the outer electrode vertical to an axis direction of the outer electrode, the end part located close to the bottom of the accommodation space is smaller than a cross-section of other part of the outer electrode vertical to the axis direction, and
the seal is disposed in an outside of the outer electrode close to the bottom of the accommodation space.

12. The sensor device as in claim 11, wherein
the inner electrode has a circumference surface elongating along the axis direction and having a tubular shape, and
a cross-section area of an end part of the inner electrode vertical to the axis direction, the end part located close to the bottom of the accommodation space, is smaller than a cross-section of other part of the inner electrode vertical to the axis direction.
